(19) United States
(12) Patent Application Publication
(10) Pub. No.: US 2005/0039529 A1
(43) Pub. Date: Feb. 24, 2005

(54) Inertial rotation sensor having its sensing element mounted directly on the body

(76) Inventors: Alain Jeanroy, Conflans Sainte-Honorine (FR); Jean-Michel Caron, Saint-Gratien (FR)

Correspondence Address: BIRCH STEWART KOLASCH & BIRCH, PO BOX 747, FALLS CHURCH, VA, 22040-0747, US

(21) Appl. No.: 10/915,336

(22) Filed: Aug. 11, 2004

(30) Foreign Application Priority Data
Aug. 19, 2003 (FR) 0310003

(51) Int. Cl. G01P 3/00; G01P 15/00

(52) U.S. Cl. 73/497; 73/514.01

(57) ABSTRACT

The inertial rotation sensor comprises a body in which there are mounted sensing elements each comprising a bell-shaped resonator secured facing electrodes carried by an electrode-carrier stand, the body being made of a material having a coefficient of thermal expansion close to that of the electrode-carrier stand, and the electrode-carrier stand being secured directly on the body.

The present invention relates to an inertial rotation sensor.

### BACKGROUND OF THE INVENTION

Inertial rotation sensors are known that comprise a body, generally made of aluminum, carrying three sensing elements whose axes extend in orthogonal directions so that the measurement of rotation performed by each resonator enables the trajectory followed by the object carrying the sensor to be determined in three dimensions.

Each sensing element comprises a resonator in the form of a substantially hemispherical bell, generally made of silica, fixed on a stand also made of silica and carrying main electrodes together with one or more guard electrodes adjacent to the main electrodes. The assembly needs to be maintained in a vacuum so as to avoid disturbing the operation of the resonator by gaseous damping.

There then arises the problem of making mechanical and electrical connections between the sensing element and the sensor body which is generally made of aluminum.

The coefficient of thermal expansion of the aluminum body is very different from that of the sensing element made of silica. In order to avoid inducing mechanical stresses in the electrode-carrying stand during variations in the temperature of the body, which stresses would affect the measurements performed by the resonators, it is essential to provide a flexible connection between the electrode carrier and the sensor body. This flexible mechanical connection (generally a part in the form of a flexible clip or very fine rods working in bending) is generally disposed between the electrode-carrier stand and a base made of a metal material having a coefficient of expansion close to that of the body. The base of the assembly, when made in this way, can easily be secured to the body by adhesive, soldering, or any other fastening means, since the coefficient of expansion of the two parts to be united are very close (it is conventional to make the base out of the same material as the body).

Nevertheless, it should be observed that this flexible connection introduces parasitic resonant frequencies which interfere with the quality of the measurements performed, and which therefore contribute additional constraints in the design of the sensor.

Furthermore, the various electrodes carried by the electrode-carrier stand made of silica must be capable of being connected to the processor unit that enables the hemispherical resonator to function via a system of electrical connections that comply with the requirement for the resonator to operate in a vacuum. This system is generally constituted by rods passing through the base in leaktight manner. The same rods may also be used as flexible mechanical supports (very fine rods working in bending) for the electrode carrier, as mentioned above.

Presently-available technology sets a minimum dimension on the leaktight electrical connections, and the flexible mechanical connection is optionally provided independently of the electrical connections, which given the number of electrodes for connection and the mechanical constraints to be complied with, leads to the base and the electrode carrier being large in size.

From the above, it results that the total volume of each sensing element is at least about 40 cubic centimeters (cm³) to 60 cm³, and that reducing the size of the resonator does not enable the overall size of the rotation sensor to be reduced.

### OBJECT OF THE INVENTION

An object of the invention is to provide an inertial rotation sensor presenting a volume that is smaller than that of prior sensors, while having performance that is at least equal to that of prior sensors.

### BRIEF SUMMARY OF THE INVENTION

In order to achieve this object, the invention provides an inertial rotation sensor comprising a body in which there is mounted at least one sensing element comprising a bell-shaped resonator fixed facing electrodes carried by an electrode-carrier stand, the body being made of a material having a coefficient of thermal expansion close to that of the electrode-carrier stand, and the electrode-carrier stand being secured directly to the body.

Thus, making the body out of a material having a coefficient of thermal expansion close to that of the electrode-carrier stand makes it possible not only to reduce the size of the sensor by eliminating the base and the associated flexible mechanical connection usually needed for mounting the resonator on the body, but also makes it possible to eliminate the parasitic resonances that result such a connection. The sensor is thus improved both in terms of compactness and in terms of performance.

In an advantageous version of the invention, the electrodes comprise connection tabs which extend over one side of the electrode-carrier stand. Thus, the electrodes can be connected to the external processor unit without it being necessary for them to pass through the electrode-carrier stand, thereby enabling the size of the electrode-carrier stand to be further reduced.

### BRIEF DESCRIPTION OF THE DRAWING

Other characteristics and advantages of the invention will appear on reading the following description given with reference to the accompanying figures, in which:

FIG. 1 is a perspective view of an inertial rotation sensor of the invention, one of the sensing elements being in place on the body;

FIG. 2 is an axial view of a resonator in section on line II-II of FIG. 3; and

FIG. 3 is a plan view of the electrodes of the sensing element taken in section on line III-III of FIG. 2.

### DETAILED DESCRIPTION OF THE INVENTION

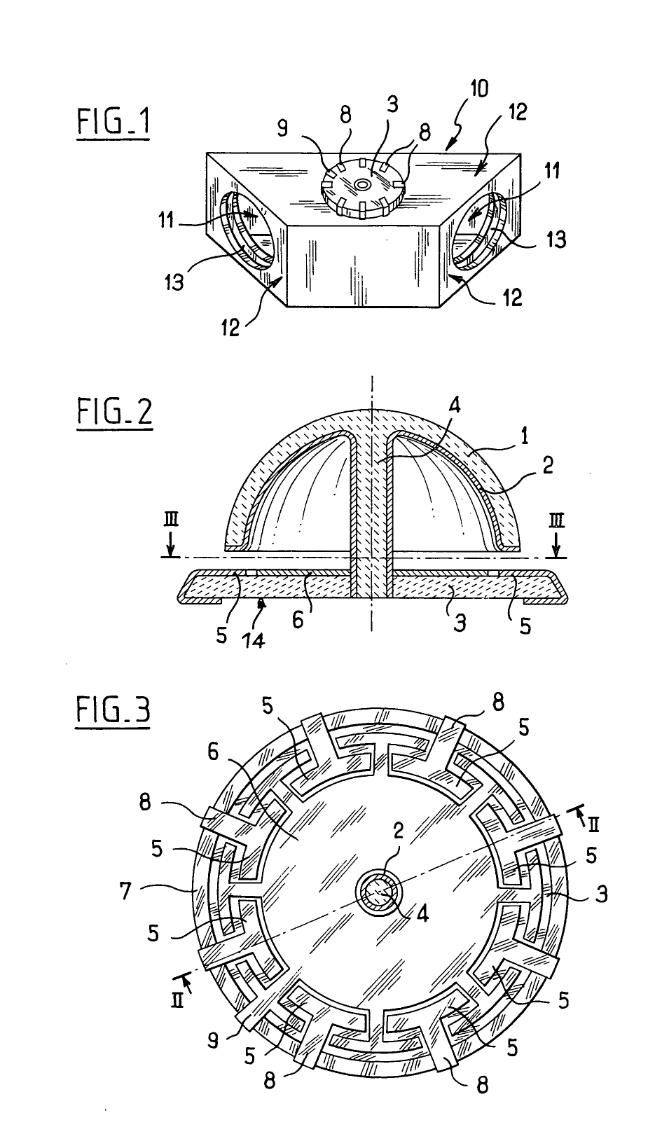

For a better understanding of the invention, the sensing element is shown in FIGS. 2 and 3 at a scale that is much greater than the scale of the body shown in FIG. 1, with the thicknesses of the electrodes and the air gaps being exaggerated.

In the embodiment shown, the sensing element comprises, in conventional manner, a hemispherical vibrator member, for example a bell made of silica and fixed by a stem 4 to a stand 3 likewise made of silica. The inside surface of the bell 1 together with its edge, and the stem 4 are covered in a layer of metal 2. The stand 3 carries main electrodes 5 and a guard electrode 6 whose edge surrounds the main electrodes 5.

According to the invention, the electrodes 5 comprise connection tabs 8 which extend over the side 7 of the electrode-carrier stand and lead to a face 14 of the electrode-carrier stand opposite from the electrodes 5. Similarly, the guard electrode 6 has a connection tab 9 which extends over the side 7 of the electrode-carrier stand and which leads onto the opposite face.

In conventional manner, the sensing elements are for mounting in a hollow body 10 having openings 11 opening out into three mutually orthogonal faces 12 that are in communication with one another.

According to the invention, the body 10 is made of a material having a coefficient of thermal expansion close to that of the electrode-carrier stand 3, e.g. silica or invar. Each electrode-carrier stand 3 is hermetically secured by adhesive directly onto a plane annular surface 13 surrounding an opening 11 (see FIG. 1).

The invention applies to rotation sensors using resonators of different diameters, both to resonators of diameter identical to those used in conventional embodiments, i.e. lying in the range 20 millimeters (mm) to 60 mm, and to resonators of smaller diameter, e.g. about 10 mm. Under such circumstances, the volume of the rotation sensor may be less than 10 cm³.

Naturally, the invention is not limited to the embodiment described and variant embodiments can be applied thereto without going beyond the ambit of the invention as defined by the claims.

In particular, although provision is made to apply adhesive directly to the edge 7 of the electrode carrier and to the connection tabs 8 and 9, provision could be made to begin by covering the edge of the electrode-carrier stand in an electrically insulating material for compensating the extra thickness provided by the connection tabs.

When the electrode-carrier stand is of a thickness such that it projects a little from the face of the body 10, as shown on the top face in FIG. 1, the connection tabs 8 and 9 may extend over the side only of the electrode carrier without extending over the face opposite from the electrodes, thereby simplifying fabrication of the connection tabs, while still enabling connections to be made easily with the processor unit without passing through the electrode-carrier stand.

It is also possible to make the electrical connection with the electrodes in conventional manner by providing respective passages through the electrode-carrier stand in register with the electrodes, and by providing sealing material in the through passages. It is also possible to make the electrical connections by ducts passing through the electrode-carrier stand in register with the electrodes and filled with conductive sealing material. This enables the electrode carrier to be made inexpensively by mass-production means of the kind known in microelectronics.

Although the resonator shown has a single guard electrode with a single connection tab 9, a plurality of connection tabs could be provided disposed symmetrically about the stem 4 of the bell in order to avoid parasitic effects due to the connection tab. It is also possible to subdivide the guard electrode into a plurality of portions forming auxiliary electrodes which extend in alternation between the main electrodes. When the connection tabs extend over the side of the electrode-carrier stand, a connection between the auxiliary electrodes connected to a common terminal can be provided on the face of the electrode-carrier stand that is opposite from the electrodes.

Although the invention is shown with a sensor comprising a body having three sensing elements, it is also possible to make a sensor having some other number of sensing elements, for example one, two, or four, on axes that are orthogonal or otherwise.

Naturally, the inertial rotation sensor of the invention may also comprise conventional members such as a member for providing a vacuum, or a member for absorbing molecules that is secured inside the body. The body may also receive accelerometers, preferably secured by adhesive.

The connection between the body and an external frame is preferably implemented by means of a resilient suspension, e.g. by elastomer studs which absorb differential expansions between the body and the external frame without disturbing the operation of the sensor.

1. An inertial rotation sensor comprising a body in which there is mounted at least one sensing element comprising a bell-shaped resonator secured facing electrodes carried by an electrode-carrier stand, the resonator and the electrode-carrier stand having coefficients of thermal expansion that are close to one another, wherein the body is made of a material having a coefficient of thermal expansion close to that of the electrode-carrier stand, and in that the electrode-carrier stand is secured directly on the body.

2. A sensor according to claim 1, wherein the resonator, the electrode-carrier stand, and the body are made of silica.

3. A sensor according to claim 1, wherein the electrodes comprise connection tabs which extend over a side of the electrode-carrier stand to lead to the outside of the body.

4. A sensor according to claim 3, wherein the connection tabs also extend over a face of the electrode-carrier stand that is opposite from the electrodes.
